(19) United States
(12) Patent Application Publication
(10) Pub. No.: US 2025/0389544 A1
(43) Pub. Date: Dec. 25, 2025

(54) OPERATING SYSTEM AND PLATFORM

(71) Applicant: Ottopia Technologies Ltd., Tel Aviv (IL)

(72) Inventors: Amit ROSENZWEIG, Tel Aviv (IL); Erez SCHNAIDER, Givatayim (IL)

(73) Assignee: Ottopia Technologies Ltd., Tel Aviv (IL)

(21) Appl. No.: 18/818,050

(22) Filed: Aug. 28, 2024

Related U.S. Application Data
(60) Provisional application No. 63/663,082, filed on Jun. 22, 2024.

(51) Int. Cl. G01C 21/34; B60W 60/00

(52) U.S. Cl. CPC G01C 21/3461; B60W 60/005

(57) ABSTRACT

Systems and methods for route building and trip planning with respect to coordinating autonomous and remote driving. Route planning data including a start location is obtained. Potential routes are identified and then optimized based on availability of autonomous driving and remote driving at different locations among the potential routes. The optimization may further account for user status with respect to remote driving service availability for the user, user preferences, or both. The optimized routes may be presented to the user for selection. A trip may be commenced based on one of the optimized routes, where the vehicle switches modes of operation including autonomous operation and remote driving operation according to the optimized route of the trip.

### CROSS-REFERENCE TO RELATED APPLICATIONS

This application claims the benefit of U.S. Provisional Application No. 63/663,082 filed on Jun. 22, 2024, the contents of which are hereby incorporated by reference.

### TECHNICAL FIELD

The present disclosure relates generally to autonomous and remote driving, and more specifically to planning vehicle navigation with respect to combinations of autonomous and remote driving.

### BACKGROUND

Autonomous driving (also referred to as self driving) refers to the ability of a vehicle to navigate and control locomotion such that the vehicle may travel without being operated by a human user. A vehicle control system may make driving decisions using one or more computer programs based on sensor signals captured by sensors installed on the vehicle.

Remote driving refers to driving in which at least some vehicle operations are controlled remotely, i.e., by a remote operator (also referred to as a teledriver) who is not physically inside of or otherwise occupying the vehicle. For example, a remote operator may issue commands to a vehicle remotely over one or more networks based on video feed and other inputs received from the vehicle. A remote operator may be a certified driver trained to remotely operate vehicles.

Manual driving refers to driving by a driver occupying a vehicle. Autonomous driving, remote driving, or both, may be utilized to reduce the amount of manual driving needed in order to travel to a destination. While manual driving may be less convenient for an occupant of the vehicle may use more of the occupant's time than either autonomous or remote driving, manual driving can be performed regardless of network conditions and in situations where autonomous driving may not be effective. Manual driving may be unassisted (i.e., no automated assistance features) or be assisted (e.g., using automated assistance features such as lane assist, backup warning, and the like).

Both autonomous driving and remote driving have their own benefits and limitations. For example, autonomous driving systems often perform poorly under certain conditions, while remote driving requires a human operator. As a result, techniques for optimally utilizing these types of driving capabilities are desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for route building. The method comprises: determining an autonomous driving availability for a route based on at least one performance metric for a plurality of locations along the route, wherein the autonomous driving availability is availability of a vehicle to operate based on instructions from at least one system of the vehicle; determining a remote driving availability for the route based on expected network conditions at the plurality of locations along the route, wherein the remote driving availability is availability of the vehicle to operate based on instructions from a remote system which is remote from the vehicle; and optimizing the route by applying a weighted graph algorithm to a plurality of values representing at least the autonomous driving availability and the remote driving availability along the route, wherein the route is optimized such that at least a first portion of the route is navigated using autonomous driving and at least a second portion of the route is navigated using remote driving.

Certain embodiments disclosed herein also include a non-transitory computer readable medium having stored thereon causing a processing circuitry to execute a process, the process comprising: determining an autonomous driving availability for a route based on at least one performance metric for a plurality of locations along the route, wherein the autonomous driving availability is availability of a vehicle to operate based on instructions from at least one system of the vehicle; determining a remote driving availability for the route based on expected network conditions at the plurality of locations along the route, wherein the remote driving availability is availability of the vehicle to operate based on instructions from a remote system which is remote from the vehicle; and optimizing the route by applying a weighted graph algorithm to a plurality of values representing at least the autonomous driving availability and the remote driving availability along the route, wherein the route is optimized such that at least a first portion of the route is navigated using autonomous driving and at least a second portion of the route is navigated using remote driving.

Certain embodiments disclosed herein also include a system for route building. The system comprises: a processing circuitry; and a memory, the memory containing instructions that, when executed by the processing circuitry, configure the system to: determine an autonomous driving availability for a route based on at least one performance metric for a plurality of locations along the route, wherein the autonomous driving availability is availability of a vehicle to operate based on instructions from at least one system of the vehicle; determine a remote driving availability for the route based on expected network conditions at the plurality of locations along the route, wherein the remote driving availability is availability of the vehicle to operate based on instructions from a remote system which is remote from the vehicle; and optimize the route by applying a weighted graph algorithm to a plurality of values representing at least the autonomous driving availability and the remote driving availability along the route, wherein the route is optimized such that at least a first portion of the route is navigated using autonomous driving and at least a second portion of the route is navigated using remote driving.

Certain embodiments disclosed herein include a method, non-transitory computer readable medium, or system as noted above or below, further including or being configured to perform the following step or steps: determining an amount of remote driving service available to a user of the vehicle during a time period in which the route is to be navigated, wherein the route is optimized based further the remaining amount of remote driving service.

Certain embodiments disclosed herein include a method, non-transitory computer readable medium, or system as noted above or below, further including or being configured to perform the following step or steps: identifying at least one service provider location with respect to the route based on a service request, wherein the route is optimized based further on the at least one service provider location.

Certain embodiments disclosed herein include a method, non-transitory computer readable medium, or system as noted above or below, further including or being configured to perform the following step or steps: training a machine learning model to learn user preferences of a user with respect to remote driving, wherein the machine learning model is trained using a training data set including previous usage of remote driving capabilities by the user, wherein the route is optimized based further on the learned user preferences.

Certain embodiments disclosed herein include a method, non-transitory computer readable medium, or system as noted above or below, further including or being configured to perform the following step or steps: determining the autonomous driving availability by inputting at least one first location of the plurality of locations along the route to a machine learning model, wherein the machine learning model is trained to estimate autonomous driving availability at a location of each of the at least one first location, wherein the machine learning model is trained based on a training data set including at least one driving performance metric measured at the location of each of the at least one first location.

Certain embodiments disclosed herein include a method, non-transitory computer readable medium, or system as noted above or below, further including or being configured to perform the following step or steps: determining the remote driving availability by inputting at least one first location of the plurality of locations along the route to a machine learning model, wherein the machine learning model is trained to estimate remote driving availability at a location of each of the locations, wherein the machine learning model is trained based on a training data set including historical network condition data for the location of each of the at least one first location.

Certain embodiments disclosed herein include a method, non-transitory computer readable medium, or system as noted above or below, wherein the optimized route is a first optimized route for a first route among a plurality of routes, further including or being configured to perform the following step or steps: determining an autonomous driving availability and a remote driving availability for each of the plurality of routes; optimizing each of the plurality of routes in order to create a plurality of optimized routes including the first optimized route; and presenting each of the plurality of optimized routes to a user.

Certain embodiments disclosed herein include a method, non-transitory computer readable medium, or system as noted above or below, further including or being configured to perform the following step or steps: receiving a selection of one of the plurality of optimized routes from the user; and executing the selected route.

Certain embodiments disclosed herein include a method, non-transitory computer readable medium, or system as noted above or below, further including or being configured to perform the following step or steps: executing the optimized route by causing the vehicle to navigate using autonomous driving during at least the first portion of the route and to navigate using remote driving during at least the second portion of the route.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a diagram illustrating route building in accordance with various disclosed embodiments.

FIG. 3 is a diagram illustrating trip planning for services requests with respect to service providers (businesses) in accordance with various disclosed embodiments.

FIG. 4 is a diagram illustrating trip planning in accordance with various disclosed embodiments.

FIG. 5 is a diagram illustrating planning at least a portion of a trip for a service request in accordance with various disclosed embodiments.

FIG. 6 is a flowchart illustrating a method for route building according to an embodiment.

FIG. 7 is a flowchart illustrating a method for determining user status according to an embodiment.

FIG. 8 is a flowchart illustrating a method for processing a service request according to an embodiment.

FIG. 9 is a flowchart illustrating a method for enhancing user experience with route building according to an embodiment.

FIG. 10 is a schematic diagram of a trip planner according to an embodiment.

FIG. 11 is a schematic diagram of a vehicle control system according to an embodiment.

### DETAILED DESCRIPTION

In light of the deficiencies of both autonomous and remote driving, it has been identified that the advantages of each option can be used to cover disadvantages of the other option. More specifically, it has been identified that autonomous driving tends to perform worse in certain locations in a predictable manner which can be learned over time (e.g., using machine learning). Although remote driving can be utilized to fill these gaps in autonomous driving coverage, remote driving requires a network connection, which may cause remote driving solutions to perform worse in locations with poor network coverage. Additionally, remote driving carries additional computing and networking resources, and requires a manual operator.

Accordingly, the disclosed embodiments include various techniques and systems which utilize combinations of autonomous and remote driving in order to improve coverage of driving which does not require occupants of a vehicle to manually drive or which otherwise minimizes the amount of driving performed by occupants of a vehicle. The disclosed embodiments include techniques for trip planning, both prior to trips as well as on-the-fly and in real-time during a drive. Various disclosed embodiments utilize assumptions such as autonomous driving being higher priority than remote driving overall, as well as both autonomous driving and remote driving being higher priority than manual driving.

Additionally, it has been identified that, since network connections may not always be available for a vehicle, controlling different forms of navigation centrally in a vehicle control system would allow for maximizing availability and continuity of control while the vehicle is navigating. Moreover, it has been identified that using both autonomous and remote driving in a given trip may require accounting for variance in space and time based on expected navigation of the vehicle, and that driving modes may need to switch from autonomous to remote in real-time in certain situations. Accordingly, various disclosed embodiments may be realized as an operating system, one or more computer program, or a combination thereof, installed in a computing system of the vehicle. Such an operating system, computer programs, or both, may act as a backend for control over vehicle modes including autonomous and remote driving.

Moreover, such an on-vehicle system may allow for adjusting to changes in circumstances which may present safety hazards in real-time, for example by changing route plans to utilize manual driving, or otherwise switch modes when one mode of operation (e.g., autonomous or remote driving) becomes incapable of safely navigating the vehicle during a trip. As a non-limiting example, if conditions on the road become unsafe for autonomous driving or one or more systems required for autonomous driving on the vehicle fail, then mode of operation may switch to remote driving at least temporarily in order to ensure safety.

Various disclosed embodiments may be utilized to provide trip planning, trip recommendations and notifications, trip summaries, demonstrations of remaining monthly remote driving credits, understanding of different remote driving plans, combinations thereof, and the like. This data may be consumed via an application (e.g., an application installed on a smartphone of a user occupying the vehicle), or consumed directly via a dedicated user interface in the vehicle.

To balance autonomous driving and remote driving against other factors (e.g., user preferences, availability of remote driving, etc.), various disclosed embodiments utilize a weighted graph algorithm.

In addition to various technical advantages discussed herein, the disclosed embodiments may allow for improving user experiences in situations involving purchasing a vehicle equipped with autonomous driving and remote driving capabilities. As a non-limiting example, route planning as disclosed herein may be utilized during a shopping experience in order to demonstrate examples of potential navigation routes in order to illustrate relative amounts of autonomous and remote driving which may be needed to accomplish certain routes the user is interested in.

In addition to the computing and networking resource costs noted above, remote driving may carry higher monetary costs as compared to autonomous driving. That is, because remote driving requires human operators, remote driving pricing models may utilize pay per minute (time-based billing), pay per mile (distance-based billing), or other billing models which increase costs the more remote driving is utilized. As a result, users may prefer to minimize remote driving in order to save costs. The disclosed embodiments may be utilized to identify where autonomous driving may be utilized instead of remote driving in order to minimize use of remote driving.

Moreover, various disclosed embodiments may be utilized to determine routes which minimize remote driving even if the route is overall longer (e.g., further distance or longer time spent driving). Alternatively, multiple routes may be determined and presented to a user in order to allow the user to choose in accordance with their preferences. Such user preferences may defined with respect to factors such as, but are not limited to, willingness to drive manually (e.g., whether the user is willing to manually drive for a portion of a route, a degree of manual driving the user is willing to drive), amount of remote driving (e.g., how much of available remote driving is the user willing to use for a given trip), distance (e.g., how far is the user willing to travel for a given trip), cost, service-specific preferences (e.g., parking, maintenance, car wash, etc.), acceptability of vehicle usage (e.g., as defined with respect to fuel consumption), charge consumption (e.g., for electric vehicles) or otherwise with respect to effects of distance on the vehicle such as wear and tear), combinations thereof, and the like.

For example, different routes may be optimized for different metrics (e.g., trip length, trip distance, and amount of remote driving). Further, user preferences may be learned over time using machine learning in order to provide automated route decisions or suggestions. As a non-limiting example, machine learning may be utilized based on previous usage of remote driving to determine that a user prefers to avoid driving at certain times of day (e.g., in the evening on weekdays), and routes which utilize more remote driving in order to minimize or avoid manual driving may be selected for or suggested to the user.

Various disclosed embodiments may be integrated, for example via application programming interfaces (APIs), with different systems in order to provide enhanced functionality. Such integrations may include, but are not limited to, parking software applications, toll road systems, payment systems, original equipment manufacturer (OEM) infotainment systems, combinations thereof, and the like. As a non-limiting example, the disclosed embodiments may determine parking garages which can be navigated to while maximizing autonomous driving as compared to remote driving, and suggest those parking garages to the user for destinations to park the vehicle.

Additionally, some remote driving offerings utilize a credits system where a user gets a certain amount of credits per time period (e.g., per month). In addition to minimizing use of remote driving in general, various disclosed embodiments may be utilized to plan routes that reduce use of remote driving to specific amounts in order to avoid going beyond available credit limits.

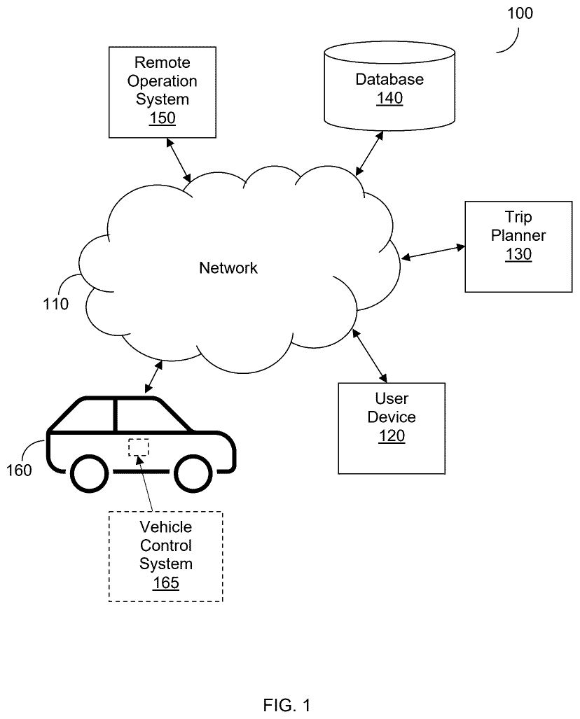

FIG. 1 is a network diagram 100 utilized to describe various disclosed embodiments. As shown in FIG. 1, a user device 120, a trip planner 130, a database 140, a remote operation system 150, and a vehicle 160 communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The user device may be, but is not limited to, a personal computer, a laptop, a tablet computer, a smartphone, a wearable computing device, or any other device capable of receiving and displaying digital maps, vehicle feature choices, both, and the like.

The trip planner 130 may be configured to perform route building in accordance with various disclosed embodiments. In some implementations, the trip planner 130 may be configured to communicate with the remote operation system 150 directly, or may be realized as a component of the remote operation system 150.

The database 140 may store data such as, but not limited to, data regarding available vehicle features for different features, historical data related to autonomous driving performance, historical data related to network connections, combinations thereof, and the like.

The remote operation system 150 is configured to remotely control at least a portion of operations of the vehicle 160 by a remote operator. In other words, the remote operation system 150 controls remote driving of the vehicle based on inputs from such a remote operator.

The vehicle 160 is configured to drive in different modes including autonomous driving, remote driving, and manual driving. The vehicle 160 is equipped with a vehicle control system 165 configured to control vehicle operations, for example during autonomous driving, and to switch modes of operation (e.g., from remote driving or manual driving to autonomous driving).

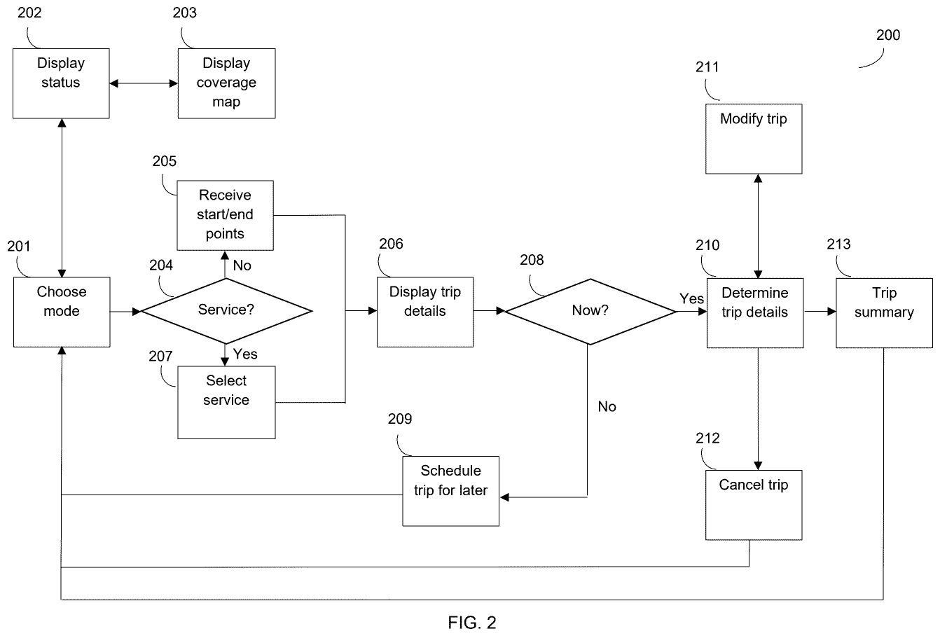

FIG. 2 is a diagram 200 illustrating route building in accordance with various disclosed embodiments. The diagram 200 illustrates a trip planning workflow, for example, from the perspective of a user.

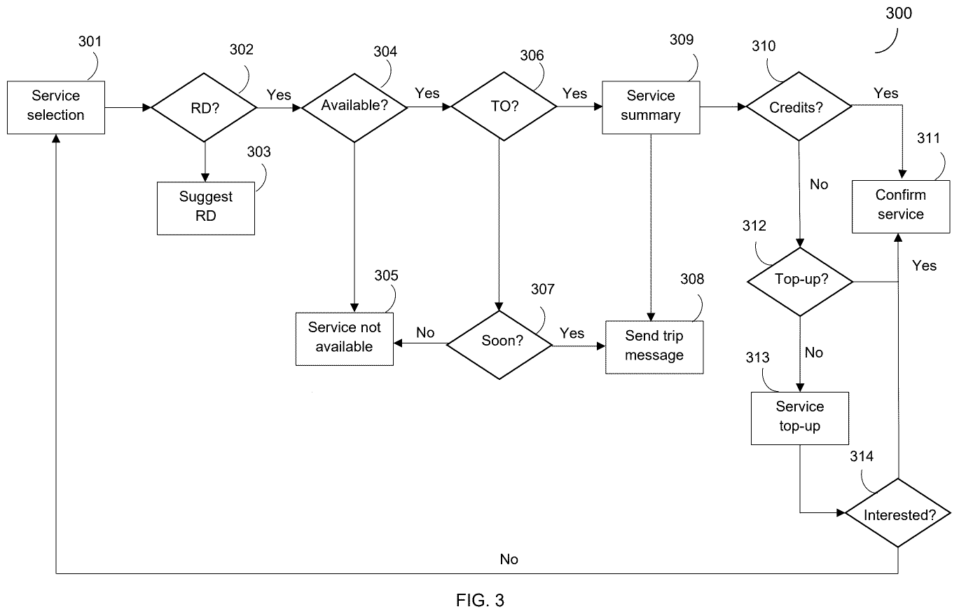

As depicted in the diagram 200, at 201, a trip structure mode is chosen via a trip planner. The chosen trip structure mode may include details related to selecting a route for the trip such as, but not limited to, any service requests which might require moving to certain service provider locations, planned departure or other details about the timing of the trip, and the like. As part of the selection of trip structure mode at 201, one or more services may be selected, for example as described further below with respect to FIG. 3.

At 202, a status page showing information about a subscription (e.g., a remote driving subscription) for a user using the trip planner is displayed. At 203, a coverage map illustrating availability of remote driving at various locations is displayed to the user.

At 204, it is determined whether the trip should include use of a service (e.g., depending on whether the initial trip structure includes or is otherwise associated with a service request). If not, at 205, a start and end point for the trip (e.g., addresses of such points) may be manually entered or otherwise provided. If the trip should include use of a service, at 206, one or more services to be used may be selected. The service selection at 206 may further include providing start and end locations (e.g., points or otherwise addresses).

At 207, trip details may be displayed by the trip planner. The trip details may be or may include details about the current trip such as, but not limited to, start and end points, service locations or requested services, planned departure time, and the like.

At 208, it may be determined whether the trip is an immediate trip (i.e., whether a departure time is within a predetermined threshold of time or not). If the trip is not an immediate trip, at 209, a trip may be scheduled for a later time. At such later time, execution may continue with trip planning at 201, where the user may optionally be prompted for any updates to the trip (like previously unrequested service requests).

If the trip is an immediate trip, at 210, ongoing trip details may be determined as the trip is conducted. Optionally, at 211, the ongoing trip may be modified, for example based on changes in autonomous or remote driving availability, new service requests received from the user during the trip, and the like. Likewise, optionally at 212, the ongoing trip may be cancelled (e.g., based on a user input requesting that the trip be cancelled). At 213, a trip summary, optionally including any costs of the trip, may be output to a user. The use may optionally select a new trip structure mode at 201 after viewing the trip summary output at 213.

FIG. 3 is a diagram 300 illustrating trip planning for services requests with respect to service providers (businesses) in accordance with various disclosed embodiments. The diagram 300 illustrates a trip planning workflow for a chosen service and, specifically, a trip planning workflow for planning a trip using remote driving in order to realize a service request.

As depicted in the diagram 300, at 301, a selection of a service is received. At 302, it is determined whether remote driving (RD) is enabled for a vehicle. If not, execution may continue with 303, where a suggestion to consider enabling remote driving may be output (e.g., a suggestion stating “This service can be shorter with remote drive.”). That is, if remote driving is not enabled, the user may be prompted to enable remote driving in order to facilitate driving the user to a service location for the service.

If remote driving is enabled, at 304, it is determined whether the selected service is available. If not, at 305, a message indicating that the service is unavailable may be returned to a user and the user may be prompted to make another service selection.

If the service is available, at 306, it may be determined whether there is currently a sufficient teleoperator (TO) capacity to accommodate remote driving to a service location for the service. If not, at 307, it is determined whether there is teleoperator capacity within a predetermined period of time (e.g., less than 5 minutes). In other words, at 306, it is determined whether a teleoperator is currently available to remotely drive the vehicle. If sufficient teleoperator capacity is not available within the predetermined period of time, execution may continue with 305 where a message indicating that the service is unavailable is returned to the user. If sufficient teleoperator capacity is available within a predetermined period of time, a message indicating that the trip will commence soon may be sent to the user at 308 and execution may proceed with 309.

If sufficient teleoperator capacity is currently available as determined at 306 or if the capacity is available within a predetermined period of time, then a service summary may be provided to the user at 309. The service summary may indicate, for example, the service location to which the vehicle will be navigated using remote driving in order to receive the service.

At 310, it is determined whether the user of the vehicle or otherwise whether the vehicle has access to a sufficient number of teleoperator credits in order to complete the service navigation using remote driving. If so, at 311, a confirmation message prompting the user to confirm the service may be displayed to the user in order to allow the user to confirm the user of remote driving for the service request.

If sufficient teleoperator credits are not available, then at 312, the user may be prompted for an automatic top-up of credits, for example using a payment method associated with the user. If the user agrees to the automatic top-up, then execution may proceed with 311 where a confirmation of service message is displayed to the user. Otherwise, the user may be prompted to top-up their available teleoperator credits at 313. At 314, it is checked if the user has topped up their credits and, if so, execution continues with 311; otherwise, execution may return to 301 (as shown) or terminate (not shown).

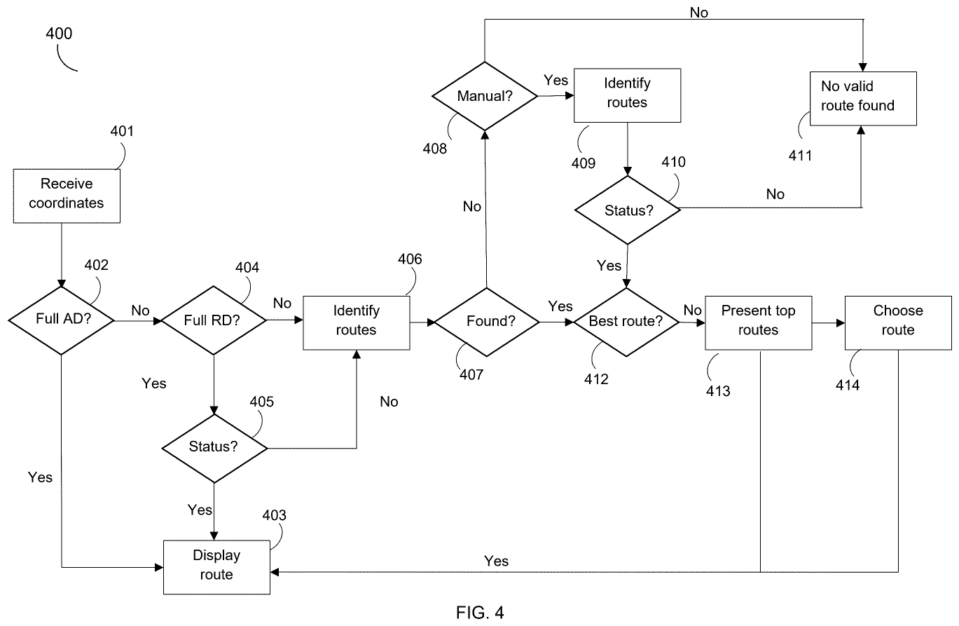

FIG. 4 is a diagram 400 illustrating trip planning in accordance with various disclosed embodiments. The diagram 400 illustrates a workflow which may be utilized, for example, when route planning data indicates both a start location and an end location.

As depicted in the diagram 400, start and end coordinates (i.e., coordinates of the start location and the end location, respectively) are received at 401. At 402, it is determined whether the trip being planned can be navigated fully autonomously (i.e., only using autonomous driving). If so, at 403, a route including the start and end coordinates which can be navigated fully autonomously is identified and displayed to a user.

If the trip being planned cannot be navigated fully autonomously, then at 404 it is determined whether the trip can be navigated fully remotely (i.e., only using remote driving, or RD) and, if so, at 405, it is checked whether a fully remote driving route meets a status of the user (e.g., would use an amount of teleoperator credits that is less than or equal to an amount of teleoperator credits associated with the user). If a fully remote route exists as determined at 404, then execution may proceed to 403 where the route is shown to the user.

If either 404 or 405 results in a “no” answer, then execution may proceed with 406, where a set of routes each including a mix of autonomous driving and remote driving is identified. At 407, it is checked whether such a route has been found. If not, execution proceeds to 408, where the user is prompted to indicate whether the user would be willing to manually drive the vehicle (i.e., without using autonomous or remote driving) for at least a portion of the trip. If the user is willing to manually drive the vehicle, then at 409, a set of routes which include a mix of autonomous driving, remote driving, and manual driving is identified and execution proceeds with 410.

At 410, it is checked whether the identified route meets a status of the user (e.g., would use an amount of teleoperator credits that is less than or equal to an amount of teleoperator credits associated with the user or otherwise complies with one or more user preference rules associated with the user). If not, at 411, a message indicating that a valid route has not been found may be returned.

If either 407 or 410 results in a “yes” answer, than at 412, it is checked whether a single route should be presented to the user (e.g., as opposed to multiple routes). In an embodiment, 412 includes applying one or more route determination rules that define when one option should be presented instead of multiple, for example, by defining a set of criteria that, when met, results in selecting a single option instead of multiple. If a single route is determined, then execution proceeds with 403 where that route is presented to the user.

If a single route is not determined, then at 413, a predetermined number of top routes (e.g., 3) may be presented to the user and the user may select one of the routes at 414. The selected route may then be presented to the user as the route to use at 403.

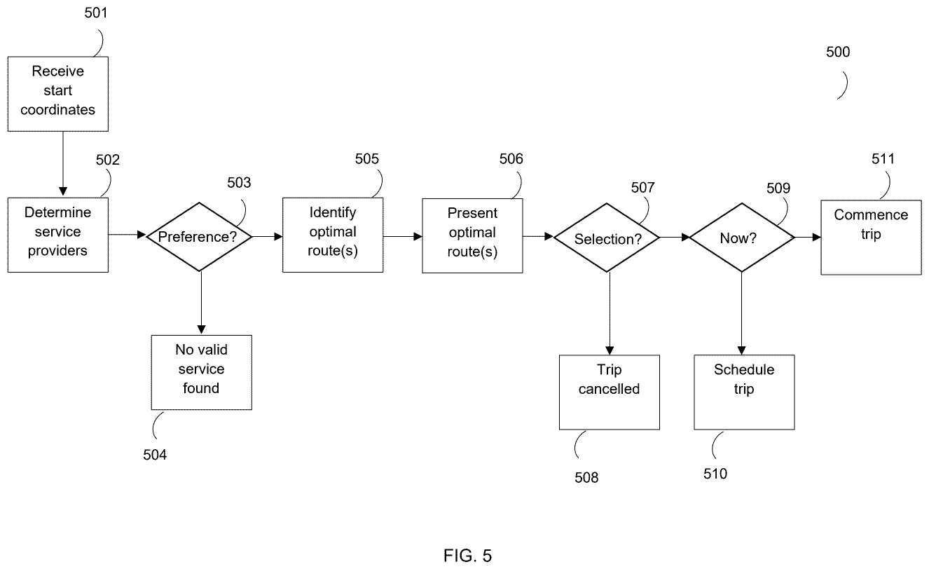

FIG. 5 is a diagram 500 illustrating planning at least a portion of a trip for a service request in accordance with various disclosed embodiments.

As depicted in the diagram 500, at 501, start coordinates and a type of service being requested are received. At 502, a list of service providers which provide the service is determined. At 503, it is checked if any of the service providers among the list meet one or more user preferences and, if not, execution proceeds with 504 where a message indicating that no valid service was found is returned. Otherwise, at 505, an optimal route including a service location of each service provider at which the requested service may be performed is identified.

At 506, one or more of the optimal routes are presented to the user. As a non-limiting example, a predetermined number of routes including stops at respective service provider locations (e.g., 3 routes) may be presented. At 507, it is checked whether the user selected a route (and, consequently, a service provider of the service provider location along the optimized route) and, if not, at 508 a message indicating that the trip has been cancelled may be presented to the user. Otherwise, at 509, it is determined whether the trip is immediate (e.g., within a predetermined amount of time from now).

If the trip is not an immediate trip, then the trip is scheduled for a future time at 510. If the trip is an immediate trip, then the trip is commenced at 511.

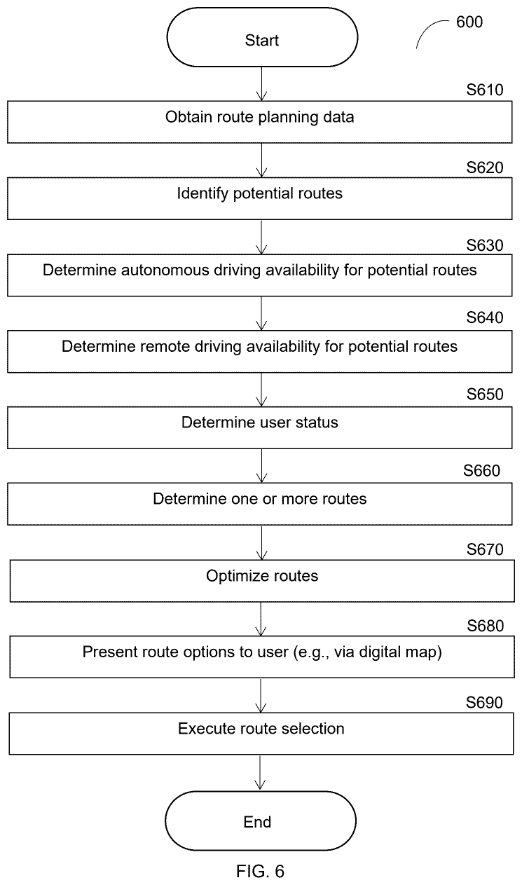

FIG. 6 is a flowchart 600 illustrating a method for route building according to an embodiment. In an embodiment, the method is performed by the trip planner 130. In another embodiment, the method is performed by the vehicle control system 165.

At S610, route planning data is obtained. In an embodiment, the route planning data includes a start location and further includes an end location (e.g., a location of a destination), a requested service type, or both. Moreover, in at least some implementations, route building may be coordinated among multiple trips (e.g., a round trip drive including a drive from a first location to a second and then back from the second location to a first location). Such coordination among multiple trips may be used to collectively balance autonomous and remote driving among different trips.

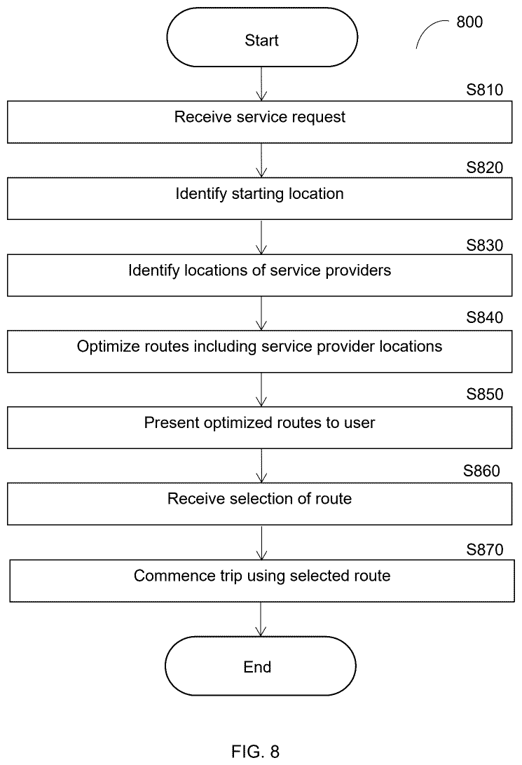

When the route planning data includes a requested service type, locations of service providers (e.g., businesses which provide the requested type of service) may be identified and utilized for route building. Route building based on service requests is described in more detail below with respect to FIG. 8.

At S620, potential routes are identified based on the route planning data. The potential routes are routes which begin at the start location and proceed to one or more stops (e.g., a destination such as the end location, one or more service provider locations, both, etc.). When the route planning data includes a requested type of service, the potential routes are routes including one or more stops at service provider locations.

At S630, an availability of autonomous driving is determined for the potential routes. The availability of autonomous driving may be location-based, time-based, or both. More specifically, autonomous driving availability may be defined based on an ability of a vehicle to effectively drive autonomously at various locations. Such an ability to effectively drive autonomously may be determined based on, for example one or more performance metrics. Moreover, the autonomous driving availability may be further determined based on a type of the vehicle, one or more autonomous driving-related features of the vehicle (e.g., availability of certain sensors, software installed on the vehicle, etc.), both, and the like.

In some embodiments, the autonomous driving availability is learned using machine learning. To this end, in an embodiment, S630 may include inputting one or more points along each potential route to a machine learning model which is trained to estimate availability of autonomous driving at a location of each point. Such a machine learning model may be trained based on training data indicating autonomous driving success (e.g., as defined with respect to one or more driving performance metrics for a vehicle driving at different locations) at different locations, at different times, or combinations thereof.

At S640, remote driving availability is determined for each of the potential routes. In an embodiment, the remote driving availability is determined based on expected network conditions for the potential routes. To this end, in some embodiments, S640 includes determining the expected network conditions for the potential routes, for example based on historical network condition data for locations among the potential routes. The network conditions may be utilized to determine remote driving availability at different locations along the potential routes.

In some embodiments, the expected network conditions are learned using machine learning. To this end, in an embodiment, S640 may include inputting one or more points along each potential route to a machine learning model which is trained to estimate availability of remote driving at a location of each point. Such a machine learning model may be trained based on training data indicating network conditions at different locations, at different times, or combinations thereof.

In some embodiments, the remote driving availability may be determined based on the user status (e.g., based on a remaining amount of remote driving credits for the user in a given time period), based on remote driver (teleoperator) availability, both, and the like.

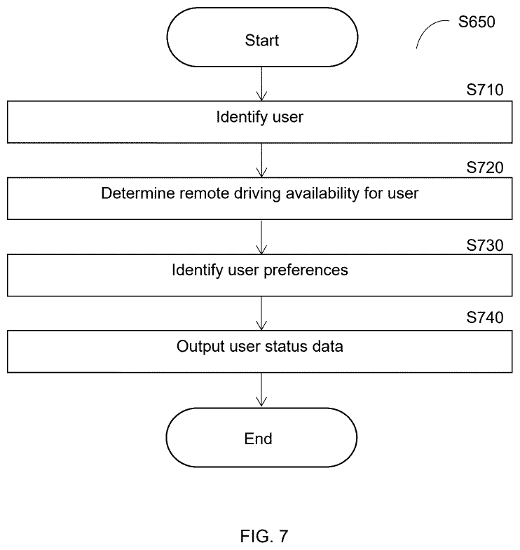

At S650, a user status is determined for a user to be transported by the vehicle during a trip. The user status may be determined with respect to, for example but not limited to, remote driving availability for the user (e.g., based on an amount of remote driving service available to the user for a given time period), one or more user preferences, or both. An example process for determining user status is discussed further below with respect to FIG. 7.

At S660, one or more routes are determined based on the potential routes and the user status. In an embodiment, S660 includes selecting one or more routes from among the potential routes which meet one or more criteria determined based on the user status. Such criteria may include, but is not limited to, adherence to limitations on remote driving (e.g., based on availability of autonomous driving at locations along each potential route and remote driving availability for the user), user preferences with respect to time, user preferences with respect to distance, combinations thereof, and the like.

In some embodiments, a single route may be determined. In other embodiments, multiple routes which meet the criteria are determined, and multiple route options may be presented to the user as discussed further below.

In some embodiments, the routes may be determined using one or more route selection rules defined with respect to maximizing autonomous driving. To this end, routes including only autonomous driving (i.e., not requiring remote driving) may be prioritized and presented over routes including both autonomous and remote driving. In such embodiments, if no routes including only autonomous driving can be determined, then routes including both autonomous and remote driving may be determined.

At S670, the determined routes are optimized. More specifically, in an embodiment, optimizing the determined routes at least includes determining one or more portions of each route to be driven autonomously and one or more portions of each route to be driven using remote driving. In a further embodiment, optimizing the determined routes may also include determining one or more portions of each route to be driven manually.

In an embodiment, optimizing the routes includes applying a weighted graph algorithm to values representing factors including but not limited to, the autonomous driving availability at different locations among the determined routes, the remote driving availability at different locations among the determined routes, availability of remote driving for the user during a time period including a time of the trip, and the user preferences.

At optional S680, the optimized routes may be presented to the user as route options. In an embodiment, S680 may include sending, to a user device, route data for each of the optimized routes. Such route data may include, but is not limited to, a navigation route of the optimized route, each portion to be driven autonomously, each portion to be driven via remote driving, each portion to be driven manually, a combination thereof, and the like. In a further embodiment, the route data may be sent as a digital map. Such a digital map may indicate the path of the route, as well as the respective portions to be driven autonomously, remotely, and manually. For example, a path of the route may be highlighted as compared to other locations on the digital map, and the portions to be driven using different operation modes (i.e., autonomous, remote, and manual) may be colored or otherwise visually distinguished from each other.

At optional S690, a route selection is received from the user, and the selected route may be executed (e.g., by causing the car to begin navigation in accordance with the modes of operation of the selected route).

FIG. 7 is a flowchart S650 illustrating a method for determining user status according to an embodiment.

At S710, a user is identified for which the user status is to be determined. The user may be a user who selected route planning parameters for routes to be determined using the user status.

At S720, a remote driving availability is determined for the user. In an embodiment, S720 includes determining a remaining amount of remote driving service (e.g., as defined with respect to distance, time, etc.) assigned to the user for a given time period including a time period in which the user is expected to travel. Such a remaining amount of remote driving service may be determined, for example, based on a remaining number of credits and a usage of credits per unit (e.g., unit of time or distance).

At S730, one or more user preferences of the user are identified.

The user preferences may be defined with respect to factors such as, but are not limited to, willingness to drive manually (e.g., whether the user is willing to manually drive for a portion of a route, a degree of manual driving the user is willing to drive), amount of remote driving (e.g., how much of available remote driving is the user willing to use for a given trip), distance (e.g., how far is the user willing to travel for a given trip), cost, service-specific preferences (e.g., parking, maintenance, car wash, etc.), acceptability of vehicle usage (e.g., as defined with respect to fuel consumption, charge consumption (e.g., for electric vehicles) or otherwise with respect to effects of distance on the vehicle such as wear and tear), combinations thereof, and the like.

In some embodiments, the user preferences may be learned over time via machine learning. To this end, S730 may include inputting data identifying the user to a machine learning model which is trained based on historical data related to choices made by the user at least with respect to autonomous and remote driving. Such a machine learning model may output values indicating preferences of the user. As a non-limiting example, a value of 1 for a potential preference being a user preference for that user, or a value of 0 indicating that a potential preference is not a user preference for that user.

At S740, user status data indicating the user status is output. The user status data may include, but is not limited to, the remote driving availability for the user, the preferences of the user, both, and the like.

FIG. 8 is a flowchart 800 illustrating a method for processing a service request according to an embodiment. In an embodiment, the method is performed by the vehicle control system 165.

At S810, a service request is received. The service request may be received, for example, via one or more user inputs. The service request at least indicates a type of service being requested (e.g., parking, refueling, etc.).

At S820, a starting location is identified. The starting location may be, but is not limited to, a current location of a vehicle, a starting location input by a user, and the like. In some embodiments, a destination location may also be identified. The destination location may be a location which should be navigated to after the vehicle stops at one or more service provider locations.

At S830, locations of service providers who offer the requested type of service are identified. The locations of the service providers may be determined based on the starting location, for example, within a threshold distance of the starting location. Alternatively or in combination, the locations of the service providers may be determined based on a destination location, for example, within a threshold distance of the destination location or within a threshold distance of one or more points along a path between the starting location and the destination location. Moreover, thresholds used for such determinations may differ depending on the requested service, different thresholds may be used for the starting and destination locations, or both.

At S840, optimized routes including one or more of the identified service provider locations are determined. In an embodiment, the optimized routes are determined as discussed further above with respect to FIG. 6. The optimized routes are determined based on potential routes including the starting location and one or more of the identified service provider locations. In some embodiments, multiple optimized routes which are optimized for different criteria (e.g., minimize remote driving, minimize travel time, minimize distance, etc.) may be determined to be presented to the user.

At S850, the optimized routes are presented to the user, for example, via a digital map on a display of a user device.

At S860, a selection of a route is received from the user (e.g., from the user device). The selection may be a selection of one of the optimized routes.

At S870, a trip is commenced using the selected route, for example, by causing the car to begin navigation in accordance with the modes of operation of the selected route.

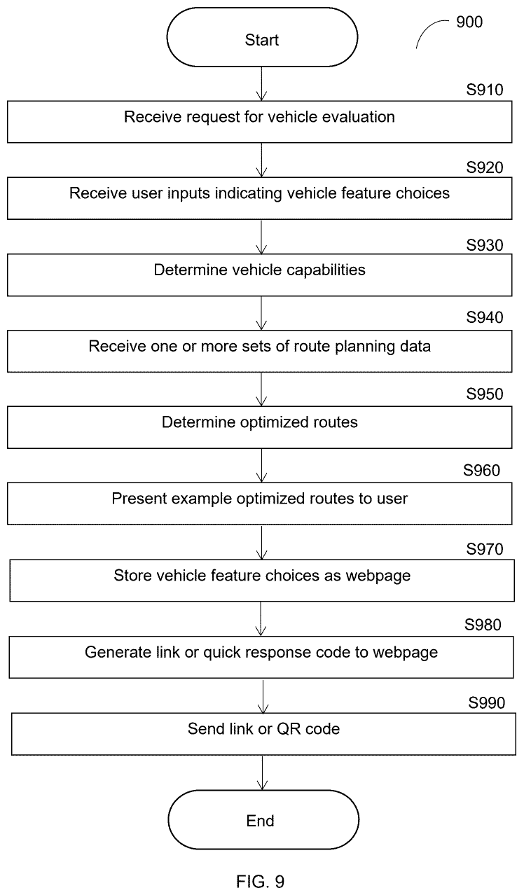

FIG. 9 is a flowchart 900 illustrating a method for enhancing user experience with route building according to an embodiment. In an embodiment, the method is performed by the trip planner 130.

At S910, a request for a vehicle evaluation is received, for example, from a user device.

At S920, user inputs indicating vehicle feature choices are received. In an embodiment, S920 includes presenting vehicle feature options to a user (e.g., via the user device). Such vehicle features may be selections of make, model, add-on features (e.g., safety features, mode of operation capabilities, etc.), combinations thereof, and the like.

At S930, vehicle capabilities are determined at least with respect to autonomous and remote driving based on the vehicle feature choices. The vehicle capabilities may include, but are not limited to, whether the vehicle is capable of both autonomous and remote driving, sensors or other equipment which may affect availability of autonomous or remote driving at a given location, both, and the like.

At S940, one or more sets of route planning data are received. In an embodiment, each set of route planning data includes a start location and further includes an end location (e.g., a location of a destination), a requested service type, or both.

At S950, one or more optimized routes are determined based on the route planning data and the vehicle capabilities. In an embodiment, the optimized routes are determined as described above with respect to FIG. 6.

At S960, the optimized routes are presented to the user as examples of optimized routes for a vehicle having the chosen vehicle features.

At S970, the vehicle feature choices are stored as a webpage. Such storage may allow for convenient accessing of such data later, for example, in order to allow a user to check out with a vehicle purchase for a vehicle having the chosen features. In an embodiment, the vehicle feature choices may be stored as a webpage once the user confirms that the user is finished selecting vehicle feature choices. As a non-limiting example, when the user has viewed the example optimized routes and is satisfied with the availability of autonomous and remote driving options for those example routes, a user may opt to check out with the chosen vehicle features and purchase the vehicle. Alternatively, the vehicle feature choices may be stored as they are made.

At S980, a link or quick response code (QR) code to the webpage containing the vehicle feature choices is generated. Such a link may be scanned (e.g., by a vehicle salesperson) in order to automatically provide the chosen vehicle features.

At S990, the generated link or QR code may be sent to a user device (e.g., a user device of the user who selected the vehicle feature choices, or of a salesperson who will check the user out based on the selected vehicle feature choices).

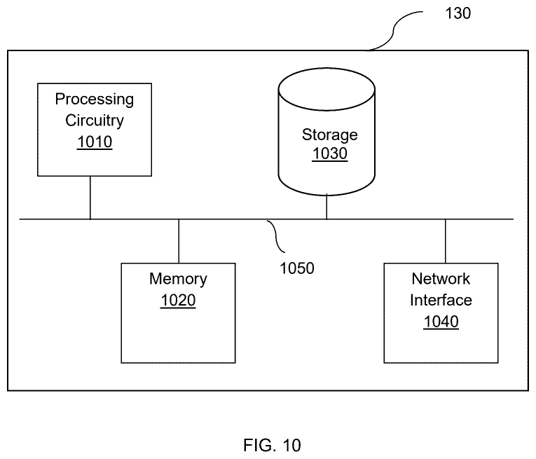

FIG. 10 is an example schematic diagram of a trip planner 130 according to an embodiment. The trip planner 130 includes a processing circuitry 1010 coupled to a memory 1020, a storage 1030, and a network interface 1040. In an embodiment, the components of the trip planner 130 may be communicatively connected via a bus 1050.

The processing circuitry 1010 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 1020 may be volatile (e.g., random access memory, etc.), non-volatile (e.g., read only memory, flash memory, etc.), or a combination thereof.

In one configuration, software for implementing one or more embodiments disclosed herein may be stored in the storage 1030. In another configuration, the memory 1020 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 1010, cause the processing circuitry 1010 to perform the various processes described herein.

The storage 1030 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 1040 allows the trip planner 130 to communicate with other systems, devices, components, applications, or other hardware or software components, for example as described herein.

It should be understood that the embodiments described herein are not limited to the specific architecture illustrated in FIG. 10, and other architectures may be equally used without departing from the scope of the disclosed embodiments.

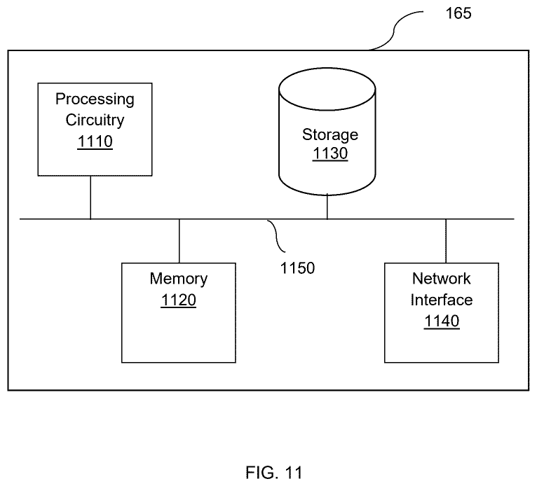

FIG. 11 is an example schematic diagram of a vehicle control system 165 according to an embodiment. The vehicle control system 165 includes a processing circuitry 1110 coupled to a memory 1120, a storage 1130, and a network interface 1140. In an embodiment, the components of the vehicle control system 165 may be communicatively connected via a bus 1150.

The processing circuitry 1110 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 1120 may be volatile (e.g., random access memory, etc.), non-volatile (e.g., read only memory, flash memory, etc.), or a combination thereof.

In one configuration, software for implementing one or more embodiments disclosed herein may be stored in the storage 1130. In another configuration, the memory 1120 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 1110, cause the processing circuitry 1110 to perform the various processes described herein.

The storage 1130 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 1140 allows the vehicle control system 165 to communicate with other systems, devices, components, applications, or other hardware or software components, for example as described herein.

It should be understood that the embodiments described herein are not limited to the specific architecture illustrated in FIG. 11, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 20; 3A; A and B in combination; B and C in combination; A and C in combination; A, B, and C in combination; 2A and C in combination; A, 3B, and 2C in combination; and the like.

What is claimed is:

1. A method for route building, comprising:
determining an autonomous driving availability for a route based on at least one performance metric for a plurality of locations along the route, wherein the autonomous driving availability is availability of a vehicle to operate based on instructions from at least one system of the vehicle;
determining a remote driving availability for the route based on expected network conditions at the plurality of locations along the route, wherein the remote driving availability is availability of the vehicle to operate based on instructions from a remote system which is remote from the vehicle; and
optimizing the route by applying a weighted graph algorithm to a plurality of values representing at least the autonomous driving availability and the remote driving availability along the route, wherein the route is optimized such that at least a first portion of the route is navigated using autonomous driving and at least a second portion of the route is navigated using remote driving.

2. The method of claim 1, further comprising:
determining an amount of remote driving service available to a user of the vehicle during a time period in which the route is to be navigated, wherein the route is optimized based further on the amount of remote driving service.

3. The method of claim 1, further comprising:
identifying at least one service provider location with respect to the route based on a service request, wherein the route is optimized based further on the at least one service provider location.

4. The method of claim 1, further comprising:
training a machine learning model to learn user preferences of a user with respect to remote driving, wherein the machine learning model is trained using a training data set including previous usage of remote driving capabilities by the user, wherein the route is optimized based further on the learned user preferences.

5. The method of claim 1, further comprising:
determining the autonomous driving availability by inputting at least one first location of the plurality of locations along the route to a machine learning model, wherein the machine learning model is trained to estimate autonomous driving availability at a location of each of the at least one first location, wherein the machine learning model is trained based on a training data set including at least one driving performance metric measured at the location of each of the at least one first location.

6. The method of claim 1, further comprising:
determining the remote driving availability by inputting at least one first location of the plurality of locations along the route to a machine learning model, wherein the machine learning model is trained to estimate remote driving availability at a location of each of the location, wherein the machine learning model is trained based on a training data set including historical network condition data for the location of each of the at least one first location.

7. The method of claim 1, wherein the optimized route is a first optimized route for a first route among a plurality of routes, further comprising:
determining an autonomous driving availability and a remote driving availability for each of the plurality of routes;
optimizing each of the plurality of routes in order to create a plurality of optimized routes including the first optimized route; and
presenting each of the plurality of optimized routes to a user.

8. The method of claim 7, further comprising:
receiving a selection of one of the plurality of optimized routes from the user; and
executing the selected route.

9. The method of claim 1, further comprising:
executing the optimized route by causing the vehicle to navigate using autonomous driving during at least the first portion of the route and to navigate using remote driving during at least the second portion of the route.

10. A non-transitory computer readable medium having stored thereon instructions for causing a processing circuitry to execute a process, the process comprising:
determining an autonomous driving availability for a route based on at least one performance metric for a plurality of locations along the route, wherein the autonomous driving availability is availability of a vehicle to operate based on instructions from at least one system of the vehicle;
determining a remote driving availability for the route based on expected network conditions at the plurality of locations along the route, wherein the remote driving availability is availability of the vehicle to operate based on instructions from a remote system which is remote from the vehicle; and
optimizing the route by applying a weighted graph algorithm to a plurality of values representing at least the autonomous driving availability and the remote driving availability along the route, wherein the route is optimized such that at least a first portion of the route is navigated using autonomous driving and at least a second portion of the route is navigated using remote driving.

11. A system for route building, comprising:
a processing circuitry; and
a memory, the memory containing instructions that, when executed by the processing circuitry, configure the system to:
determine an autonomous driving availability for a route based on at least one performance metric for a plurality of locations along the route, wherein the autonomous driving availability is availability of a vehicle to operate based on instructions from at least one system of the vehicle;
determine a remote driving availability for the route based on expected network conditions at the plurality of locations along the route, wherein the remote driving availability is availability of the vehicle to operate based on instructions from a remote system which is remote from the vehicle; and
optimize the route by applying a weighted graph algorithm to a plurality of values representing at least the autonomous driving availability and the remote driving availability along the route, wherein the route is optimized such that at least a first portion of the route is navigated using autonomous driving and at least a second portion of the route is navigated using remote driving.

12. The system of claim 11, wherein the system is further configured to:
determine an amount of remote driving service available to a user of the vehicle during a time period in which the route is to be navigated, wherein the route is optimized based further on the amount of remote driving service.

13. The system of claim 11, wherein the system is further configured to:
identify at least one service provider location with respect to the route based on a service request, wherein the route is optimized based further on the at least one service provider location.

14. The system of claim 11, wherein the system is further configured to:
train a machine learning model to learn user preferences of a user with respect to remote driving, wherein the machine learning model is trained using a training data set including previous usage of remote driving capabilities by the user, wherein the route is optimized based further on the learned user preferences.

15. The system of claim 11, wherein the system is further configured to:
determine the autonomous driving availability by inputting at least one first location of the plurality of locations along the route to a machine learning model, wherein the machine learning model is trained to estimate autonomous driving availability at a location of each of the at least one first location, wherein the machine learning model is trained based on a training data set including at least one driving performance metric measured at the location of each of the at least one first location.

16. The system of claim 11, wherein the system is further configured to:
determine the remote driving availability by inputting at least one first location of the plurality of location along the route to a machine learning model, wherein the machine learning model is trained to estimate remote driving availability at each of the plurality of locations, wherein the machine learning model is trained based on a training data set including historical network condition data for the location of each of the at least one first location.

17. The system of claim 11, wherein the optimized route is a first optimized route for a first route among a plurality of routes, wherein the system is further configured to:
determine an autonomous driving availability and a remote driving availability for each of the plurality of routes;
optimize each of the plurality of routes in order to create a plurality of optimized routes including the first optimized route; and
present each of the plurality of optimized routes to a user.

18. The system of claim 17, wherein the system is further configured to:
receive a selection of one of the plurality of optimized routes from the user; and
execute the selected route.

19. The system of claim 11, wherein the system is further configured to:
execute the optimized route by causing the vehicle to navigate using autonomous driving during at least the first portion of the route and to navigate using remote driving during at least the second portion of the route.
